(19) United States
(12) Patent Application Publication
(10) Pub. No.: US 2002/0049836 A1
(43) Pub. Date: Apr. 25, 2002

(54) Communication system, terminal device used in commuication system, and commuication method of dislaying informations

(76) Inventor: Atsushi Shibuya, Tokyo (JP)

Correspondence Address: McGuire Woods LLP, Suite, 1750 Tysons Boulevard, McLean, VA, 22102, US

(21) Appl. No.: 09/983,041

(22) Filed: Oct. 22, 2001

(30) Foreign Application Priority Data
Oct. 20, 2000 (JP) 2000-321709

(51) Int. Cl. G06F 15/16

(52) U.S. Cl. 709/219; 709/206

(57) ABSTRACT

The present invention provides a communication system including: a communication network; and a plurality of terminal device connectable to the communication network for transmitting and receiving an information through the communication network wherein the communication system includes at least a table which provides at least a retrieval condition and at least a corresponding display method to the at least retrieval condition, so as to enable the terminal device to perform a retrieval to the information under the at least retrieval condition and to display the information in accordance with the at least corresponding display method.

### BACKGROUND OF THE INVENTION

1. Field of the Invention

The present invention relates to a communication system, and a terminal device used in the communication system as well a communication method for displaying informations.

2. Description of the Related Art

In recent years, internets, e-mails and net-news have become important communication tools for obtaining, receiving and transmitting any informations and any data such as multimedia-related data including sounds, voices and images. For example, the e-mail may include text data with one or more attached-files such as image data. After receipt of the e-mail, the attached-file may be stored in a computer memory and/or displayed on a computer display screen.

The multimedia data may include static or dynamic image data. Such multimedia data may often be allocated at designated positions in web-pages in accordance with hypertext markup language (HTML) format for displaying the multimedia data on the web-pages.

The web-browser would be the extremely useful tool for access to the web-page at the web-site for downloading a web-page file together with any other file such as an image file, whereby the web-browser may display the other file such as the image file at a designated position on the web-page. The web-browser may also replay voice or sound data in addition to displaying the web-page. The image files and/or the voice or sound files are often transmitted or received together with the text data for displaying the text data with or without image data and replaying voice or sound data.

Some of the e-mail softwares and web-browser softwares may have an additional function of controlling or inhibiting the display of informations or data as transmitted from one or more pre-designated addresses. For example, one or more e-mail addresses may be recorded in the mail software to enable the mail software to automatically delete any e-mails transmitted from the recorded e-mail addresses. The web-browser nay be adjusted to control or inhibit the display of web-pages at one or more pre-designated web-sites

The conventional communication system has the following disadvantages.

First, it is necessary that image files and/or voice or sound files are transmitted, without any additional data proceedings, for displaying tie image data and/or replaying the voice or data replay. The multimedia data file such as the image file may generally have large data size which takes a long time for receiving and transmitting the multimedia data file. This time-consuming communication or transmission makes it difficult to reduce the communication cost. Storing such a large size data in the memory device or storage medium needs that the memory device or storage medium has a sufficiently large capacity.

Assuming that one or more terminal devices in the communication system are used for e-mail communications, the communications with text data only with no image file nor voice or sound file would be desirable in consideration of limited memory capacity and limited data transmission rate. The conventional communication system is suitable for transmitting or receiving small size data including text data only. It is, therefore, desirable to improve the conventional communication system in view of transmitting or receiving large size data including not only the text data but also additional multimedia data such as image or voice data.

Second, even if plural informations including plural images are to be displayed on the same display concurrently, the plural images are separately downloaded. In order to reduce the number of necessary downloading times for the image files, the web-browser is adopted to store downloaded image files into a cache-memory and then read the image files out of the cache-memory for displaying the images. This method is effective but only for the same file at the same address over the network. If the same image files are recorded at different web-sites, plural times of downloading operations are necessary. In any events, those files are once downloaded to be stored in the cache-memory at least one time. The conventional communication system does not allow that another terminal device of a counter-party displays and/or replays the multimedia data including imago and/or voice data designated by the user, without user's operation of downloading the multimedia data.

Third, the conventional communication system is unable to arrange or adopt the received respective informations for realizing the desirable display. Namely, the conventional communication system is capable of simply deciding the issue of whether or not each information is displayed. This decision is made according to the sender's address. Thus, it is difficult for the conventional system to realize the desirable display in view of the contents of the received information. Even if the urgent mail is received and simply displayed, then the subscriber or user may be not aware of this mail being urgent. He or she will be aware of the urgency upon viewing the mail description to the effect that this mail is urgent. It is, therefore, desirable to display any mark about priority or alert the priority.

Further, the conventional communication system and the conventional terminal device are unable to notify the user of the gist of the e-mail contents by automatically producing a predetermined sound or displaying a predetermined mark.

In the above circumstances, the development of a novel communication system, and a communication device used in the communication system as well as a communication program and a communication method for controlling a display of informations free from the above problems is desirable.

### SUMMARY OF THE INVENTION

Accordingly, it is an object of the present invention to provide a novel communication system free from the above problems.

It is a further object of the present invention to provide a novel communication system allowing a terminal device of a counter-party to display and/or replay multimedia data including image and/or voice or sound data which have been designated by the user, without any additional operation of downloading the multimedia data, so as to realize desirable high speed communications of the e-mail including the multimedia data such as image data to be displayed and/or voice or sound data to be replayed.

It is a still further object of the present invention to provide a novel communication system free of any serious problem with communication-traffic delay.

It is yet a further object of the present invention to provide a novel communication system which arranges or adopts received respective informations for realizing the desirable display on a single display screen.

It is further more object of the present invention to provide a novel communication system capable of automatically switching or selecting display operations via automatic detection of one or more designated key words from text or titles of the e-mails.

It is moreover object of the present invention to provide a novel communication system capable of automatically controlling the background display or the effective sound or voice in accordance with character-only-descriptions.

It is still more object of the present invention to provide a novel communication system including a display-operation-defining table which defines the display operation, wherein the display-operation-defining table is programmable by user through any available interface in order to optionally define the display-operations in the user's discretion.

It is yet more object of the present invention to provide a novel communication system including a display-operation-defining table which defines the display operation, wherein the display-operation-defining table is inter-exchangeable between communication devices through a communication network such as internet.

It is another object of the present invention to provide a novel communication system utilizing a display-operation-defining table which defines the display operation, wherein the display-operation-defining table common to plural users.

It is also an object of the present invention to provide a novel communication device free from the above problems.

It is a further object of the present invention to provide a novel communication device allowing a terminal device of a counter-party to display and/or replay multimedia data including image and/or voice or sound data which have been designated by the user, without any additional operation of downloading the multimedia data, so as to realize desirable high speed communications of the e-mail including the multimedia data such as image data to be displayed and/or voice or sound data to be replayed.

It is a still further object of the present invention to provide a novel communication device free of any serious problem with communication traffic delay.

It is yet a further object of the present invention to provide a novel communication device which arranges or adopts received respective informations for realizing the desirable display on a single display screen.

It is further more object of the present invention to provide a novel communication device capable of automatically switching or selecting display operations via automatic detection of one or more designated key words from text or titles of the e-mails.

It is moreover object of the present invention to provide a novel communication device capable of automatically controlling the background display or the sound or voice replay in accordance with character-only-descriptions.

It is still more object of the present invention to provide a novel communication device including a display-operation-defining table which defines the display operation, wherein the display-operation-defining table is programmable by user through any available interface in order to optionally define the display-operation in the user's discretion.

It is yet more object of the present invention to provide a novel communication device including a display-operation-defining table which defines the display operation, wherein the display-operation-defining table is inter-exchangeable between communication devices through a communication network such as Internet.

It is another object of the present invention to provide a novel communication device utilizing a display-operation-defining table which defines the display operation, wherein the display-operation-defining table is common to plural users.

It is also an object of the present invention to provide a novel communication method free from the above problems.

It is a further object of the present invention to provide a novel communication method allowing a terminal device of a counter-party to display and/or replay multimedia data including image and/or voice or sound data which have been designated by the user, without any additional operation of downloading the multimedia data, so as to realize desirable high speed communications of the e-mail including the multimedia data such as image data to be displayed and/or voice or sound data to be replayed.

It is a still further object of the present invention to provide a novel communication method free of any serious problem with communication traffic delay.

It is yet a further object of the present invention to provide a novel communication method which arranges or adopts received respective informations for realizing the desirable display on a single display screen.

It is further more object of the present invention to provide a novel communication method capable of automatically switching or selecting display operations via automatic detection of one or more designated key words from text or titles of the e-mails.

It is moreover object of the present invention to provide a novel communication method capable of automatically controlling the background display or the sound or voice replay in accordance with character-only-descriptions.

It is still more object of the present invention to provide a novel communication method including a display-operation-defining table which defines the display operation, wherein the display-operation-defining table is programmable by user through any available interface in order to optionally define the display-operation in the user's discretion.

It is yet more object of the present invention to provide a novel communication method including a display-operation-defining table which defines the display operation, wherein the display-operation-defining table is inter-exchangeable between communication devices through a communication network such as internet.

It is another object of the present invention to provide a novel communication method utilizing a display-operation-defining table which defines the display operation, wherein the display-operation-defining table is common to plural users.

It is also an object of the present invention to provide a novel computer-readable program for implementing desirable communications free from the above problems.

It is a further object of the present invention to provide a novel computer-readable program for implementing desirable communications allowing a terminal device of a counter-party to display and/or replay multimedia data including image and/or voice or sound data which have been designated by the user, without any additional operation of downloading the multimedia data, so as to realize desirable high speed communications of the e-mail including the multimedia data such as image data to be displayed and/or voice or sound data to be replayed.

It is a still further object of the present invention to provide a novel computer-readable program for implementing desirable communications free of any serious problem with communication traffic delay.

It is yet a further object of the present invention to provide a novel computer-readable program for implementing desirable communications, which arranges or adopts received respective informations for realizing the desirable display on a single display screen.

It is further more object of the present invention to provide a novel computer-readable program for implementing desirable communications capable of automatically switching or selecting display operations via automatic detection of one or more designated key words from text or titles of the e-mails.

It is moreover object of the present invention to provide a novel computer-readable program for implementing desirable communications capable of automatically controlling the background display or the sound or voice replay in accordance with character-only-descriptions.

It is still more object of the present invention to provide a novel computer-readable program for implementing desirable communications, which includes a display-operation-defining table which defines the display operation, wherein the display-operation-defining table is programmable by user through any available interface in order to optionally define the display-operation in the user's discretion.

It is yet more object of the present invention to provide a novel computer-readable program for implementing desirable communications, which includes a display-operation-defining table which defines the display operation, wherein the display-operation-defining table is inter-exchangeable between communication devices through a communication network such as internet.

It is another object of the present invention to provide a novel computer-readable program for implementing desirable communications, which utilizing a display-operation-defining table which defines the display operation, wherein the display-operation-defining table is common to plural users.

The present invention provides a communication system including; a communication network; and a plurality of terminal device connectable to the communication network for transmitting and receiving an information through the communication network, wherein the communication system includes at least a table which provides at least a retrieval condition and at least a corresponding display method to the at least retrieval condition, so as to enable the terminal device to perform a retrieval to the information under the at least retrieval condition and to display the information in accordance with the at least corresponding display method.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a block diagram illustrative of a communication terminal device in a first embodiment in accordance with the present invention.

FIG. 2 is a schematic perspective view illustrative of an example of the terminal device, to which the present invention is applicable.

FIG. 3 is a diagram illustrative of a network structure of a communication system in a first embodiment in accordance with the present invention.

FIG. 4 is a diagram illustrative of an example of e-mail.

FIG. 5 is a diagram illustrative of one example of key word tables used in the first embodiment in accordance with the present invention.

FIG. 6 is a flow chart illustrative of sequential operations of displaying the received e-mail by the terminal device of FIG. 1 in a first embodiment in accordance with the present invention.

FIG. 7 is a diagram illustrative of the displayed e-mail in a first embodiment in accordance with the present invention.

FIG. 8 is a diagram illustrative of a key word table in a modified embodiment in accordance with the present invention.

FIG. 9 is a flow chart illustrative of sequential operations of displaying the received e-mail by the terminal device of FIG. 1 in a modified embodiment in accordance with the present invention.

### DETAILED DESCRIPTION OF THE PREFERRED EMBODIMENTS

A first aspect of the present invention is a communication system including: a communication network; and a plurality of terminal device correctable to the communication network for transmitting and receiving an information through the communication network, wherein the communication system includes at least a table which provides at least a retrieval condition and at least a corresponding display method to the at least retrieval condition, so as to enable the terminal device to perform a retrieval to the information under the at least retrieval condition and to display the information in accordance with the at least corresponding display method. The word “table” means to include any types of data groups such as data base, which include inter-relations between data.

It is preferable that the table comprises a key table which defines at least a key object and at least a corresponding display method to the key object. It is further preferable that the at least key object comprise at least one of selected from the group consisting of key words and key marks.

It is also preferable that the table includes designating data which designate necessary data for displaying the information in accordance with the at least corresponding display method.

It is also preferable that the table includes necessary data for displaying the information in accordance with the at least corresponding display method.

It is also preferable that the table is editable.

It is also preferable that the table is transferable through the communication network.

It is also preferable that the information comprises an e-mail. The e-mail may have at least an attached file.

It is also preferable that the table is stored in a memory of the terminal device.

It is also preferable that the table is open on a server computer on the communication network, so as to enable the terminal device to download the table from the server.

It is also preferable that the terminal device includes: a first function block for performing the retrieval under the retrieval condition with reference to the table; and a second function block for displaying the information in accordance with the at least corresponding display method. It is further preferable that the terminal device further includes: a third function block for transmitting and receiving the table through the communication network.

It is also preferable that the terminal device includes: a processing unit; and a memory accessible by the processing unit, and the memory storing a computer program which comprises the stops of: performing the retrieval under the retrieval condition with reference to the table; and displaying the information in accordance with the at least corresponding display method. It is further preferable that the computer program further comprising the step of transmitting and receiving the table through the communication network.

A second aspect of the present invention is a terminal device connectable to a communication network. The terminal device comprises: a processing unit; a communication unit electrically coupled to the processing unit for transmitting and receiving an information; a display unit electrically coupled to the processing unit for displaying the information an operation unit electrically coupled to the processing unit for operating the terminal device; and a memory unit electrically coupled to the processing unit for storing at least a table which provides at least a retrieval condition and at least a corresponding display method to the at least retrieval condition, so as to enable the terminal device to perform a retrieval to the information under the at least retrieval condition and to display the information in accordance with the at least corresponding display method.

It is preferable that the table comprises a key table which defines at least a key object and at least a corresponding display method to the key object. It is also preferable that the at least key object comprise at least one of selected from the group consisting of key words and key marks.

It is further preferable that the table includes designating data which designate necessary data for displaying the information in accordance with the at least corresponding display method. It is also preferable that the table includes necessary data for displaying the information in accordance with the at least corresponding display method.

It is also preferable that the table is editable.

It is also preferable that the table is transferable from the communication unit through the communication network.

It is also preferable that the information comprises an e-mail. It is further preferable that the e-mail has at least an attached file.

It is also preferable that the terminal device includes: a first function block for performing the retrieval under the retrieval condition with reference to the table; and a second function block for displaying the information in accordance with the at least corresponding display method. It is further preferable that the terminal device further includes: a third function block for transmitting and receiving the table through the communication network.

It is also preferable that the memory stores a computer program comprising the steps of performing the retrieval under the retrieval condition with reference to the table; and displaying the information in accordance with the at least corresponding display method. It is further preferable that the computer program further comprising the step of transmitting and receiving the table through the communication network.

A third aspect of the present invention is a terminal device connectable to a communication network. The terminal device includes: a first function block for performing a retrieval to an information under at least a retrieval condition; and a second function block for displaying the information in accordance with at least a corresponding display method to the at least a retrieval condition.

It is preferable that the at least retrieval condition and the at least corresponding display method are recorded on a table. It is further preferable that the table comprises a key table which defines at least a key object and at least a corresponding display method to the key object.

It is also preferable that the table includes designating data which designate necessary data for displaying the information in accordance with the at least corresponding display method.

It is also preferable that the table includes necessary data for displaying the information ill accordance with the at least corresponding display method.

It is also preferable that the table is editable.

It is also preferable that the table is transferable from the communication unit through the communication network.

It is also preferable that the information comprises an e-mail. It is further preferable that the e-mail has at least an attached file.

A fourth embodiment of the present invention is a method of displaying an information, comprising the steps of: performing a retrieval to an information under at least a retrieval condition; and displaying the information in accordance with at least a corresponding display method to the at least a retrieval condition.

It is also preferable that the retrieval is performed with reference to at least a table which provides at least a retrieval condition and at least a corresponding display method to the at least retrieval condition, and the information is displayed in accordance with the at least corresponding display method. It is further preferable that the table comprises a key table which defines at least a key object and at least a corresponding display method to the key object. It is further preferable that the at least key object comprise at least one of selected from the group consisting of key words and key marks.

It is also preferable that the table includes designating data which designate necessary data for displaying the information in accordance with the at least corresponding display method. It is also preferable to further comprise the step of: reading out the necessary data in accordance with the designating data before displaying the information.

It is also preferable that the table includes necessary data for displaying the information in accordance with the at least corresponding display method.

It is also preferable that the information comprises an e-mail. It is further preferable that the e-mail has at least an attached file.

A fifth aspect of the present invention is a computer program of displaying an information. The computer program comprises performing a retrieval to an information under at least a retrieval condition; and displaying the information in accordance with at least a corresponding display method to the at least a retrieval condition.

It is also preferable that the retrieval is performed with reference to at least a table which provides at least a retrieval condition and at least a corresponding display method to the at least retrieval conditions and the information is displayed in accordance with the at least corresponding display method. It is also preferable that the table comprises a key table which defines at least a key object and at least a corresponding display method to the key object. It is further preferable that the at least key object comprise at least one of selected from the group consisting of key words and key marks.

It is also preferable that the table includes designating data which designate necessary data for displaying the information in accordance with the at least corresponding display method. It is also preferable to further comprise the step of: reading out the necessary data in accordance with the designating data before displaying the information.

It is also preferable that the table includes necessary data for displaying the information in accordance with the at least corresponding display method.

It is also preferable that the information comprises an e-mail. It is also preferable that the e-mail has at least an attached file.

First Embodiment:

A first embodiment according to the present invention will be described in detail with reference to the drawings. A novel communication system of the present invention allows that informations including e-mails are displayed under automatic control in accordance with a display method pre-designated depending on the informations. For example, if a predetermined mark is described in the text of the e-mail or in the title thereof, the predetermined mark is displayed as an image on the display screen with or without scrolling the display screen.

Not only the sender's address but also the text data and title of the e-mail may be browsed and retrieved to select one of the plural display measures for displaying the informations.

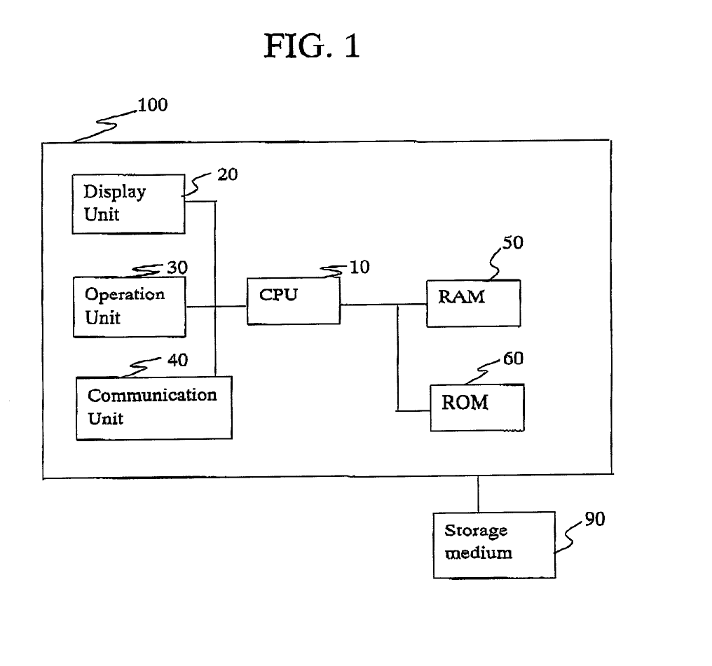

Although the following descriptions will be made by taking an example of displaying the e-mail with or without one or more attached files, but the descriptions would, of course, be applicable to displaying other contents such as net-news and web-pages of the internet. FIG. 1 illustrates the internal structure of the terminal device used in the novel communication system. A novel terminal device 100 includes a central processing unit 10, a display unit 20, an operation unit 30, a communication unit 40, and a memory which includes a random access memory 50 and a read only memory 60.

The display unit 20 is electrically connected to the central processing unit 10 for displaying the informations under the control of the central processing unit 10. The operation unit 30 is electrically connected to the central processing unit 10 for enabling the user to operate the terminal device 100 under the control of the central processing unit 10. The operation unit 30 provides an interface to the user. The communication unit 40 is electrically connected to the central processing unit 10 for transmitting and receiving the e-mail with or without one or more attached files under the control of the central processing unit 10. Tile random access memory 50 mainly stores the data, to which the central processing unit 10 is accessible for operations. The read only memory 60 mainly stores one or more programs to be implemented for operation of the central processing unit 10.

The terminal device 100 may include any communication terminal devices and any information terminal devices of mobile and non-mobile types and wire-less and wired types. The information terminal devices may, for example, be any installed type personal computers, any potable type personal computers and any personal digital assistants. The communication terminal devices may, for example, be any mobile phones and any personal handy-phone systems having additional communication functions for e-mail communication services and information providing services such as i-mode.

The display unit 20 may be any available display devices capable of displaying any characters and any images, for example, a liquid display panel of monochrome type or color type.

The operation unit 30 may comprise any available input devices such as key boards, key buttons, and input buttons for any necessary operations including designation of the information to be displayed.

The communication unit 40 performs transmitting and receiving e-mails with or with out one or more attached files as well as connecting the device to any network system such as the internet. If the device 100 is the wire-less type communication device, then the communication unit 40 may have any available antenna for transmitting and receiving radio waves. If the device 100 is the wired type communication device, then the communication unit 40 may have any available communication interface such as modern or terminal adapter to the existent wired communication lines.

The random access memory 50 may comprise a semiconductor memory for temporary storing data related to operations of the central processing unit 10 and optionally personal data for user. Optionally, an entirety or a part of the functions of the random access memory 50 may be allocated to any available auxiliary storage device such as a hard disk. The, device 100 may also be accessible to an external storage medium 90.

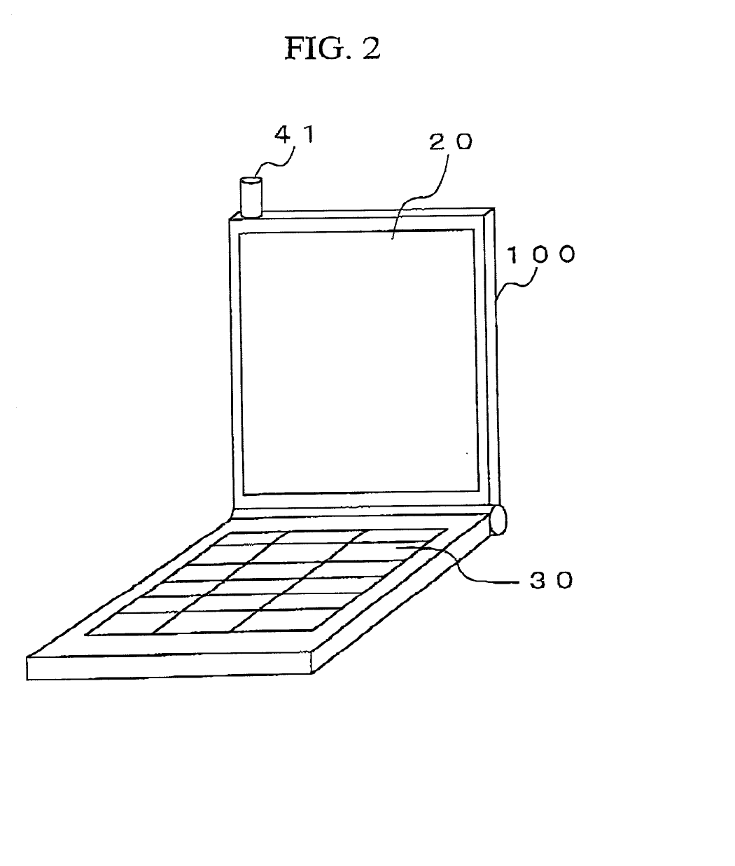

The issue of integration of the above structural elements may be optional. In FIG. 1, all of the above structural elements are integrated in the device 100. It is optional that some of the above structural elements are not integrated. With reference to FIG. 2, the above novel terminal device 100 may be the wire-less potable type personal computer. The computer 100 includes the display panel 20, the optional unit 30 and the antenna 41 which are not integrated.

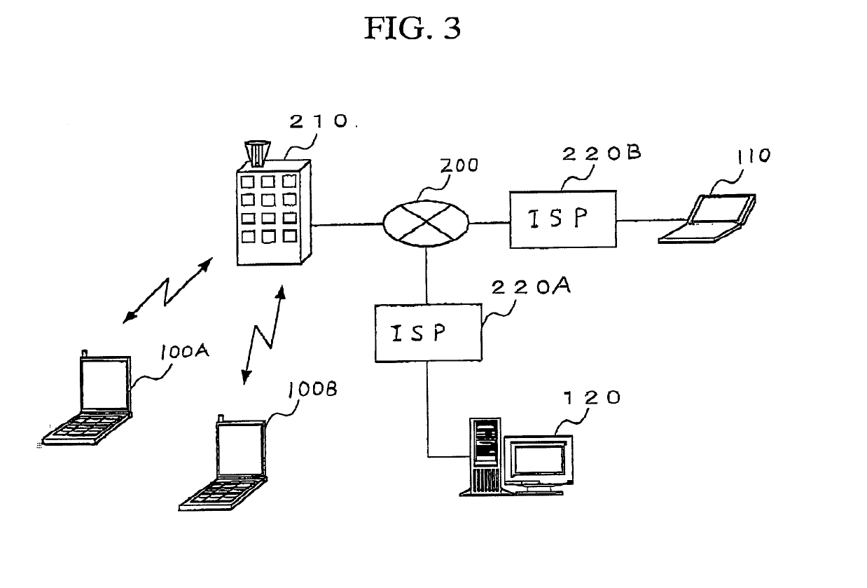

The above terminal device may be used in any available communication network systems. A communication network system shown in FIG. 3 is one example of the available communication network systems. The system includes an inter-net 200, a base station 210 connected to the inter-net 200, first and second inter-net service providers 220A and 220B connected to the inter-net 200, a wired potable personal computer 110 connected to the second inter-net service provider 220B, a wired installed type personal computer 120 connected to the first inter-net service provider 220A, and first and second wire-less terminal devices 100A and 100B electrically coupled to the base station 210.

Data communications are made between the base station 210 and the first and second wire-less terminal devices 100A and 100B through radio waves. Each of the base station 210 and the first and second inter-net service providers 220A and 220B may have a server system for accumulating and distributing e-mails. Data communications among the base station 210 and the first and second inter-net service providers 220A and 220B are made through the inter-net 200. Each of the first and second wire-less terminal devices 100A and 100B, the wired potable personal computer 110 and the wired installed type personal computer 120 has the conventional functions of connecting to the internet 200 and receiving and sending the e-mails with or without one or more attached files.

The following description will be made, assuming that the first and second wire-less terminal devices 100A and 100B have not only the above conventional functions but also novel functions described below in connection with the present invention, whilst the wired potable personal computer 110 and the wired installed type personal computer 120 have the above conventional functions only.

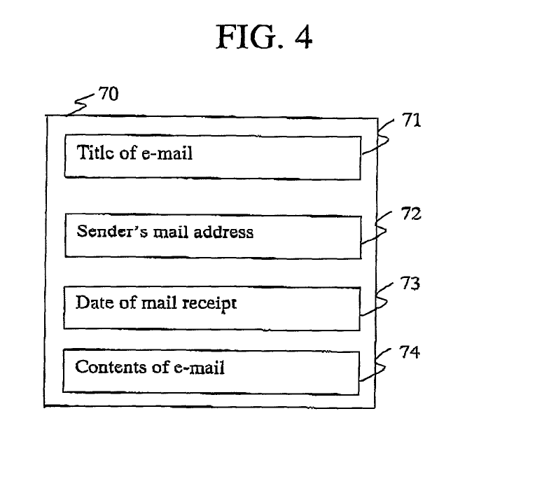

With reference to FIG. 4, the e-mail 70 may include a title 71, an sender's e-mail address 72, a receiving date 73 and a content 74. Upon receipt of the e-mail 70, the first and second wire-less terminal devices 100A and 100B judge whether the received e-mail includes one or more pre-designated key words or key marks. The first and second wire-less terminal devices 100A and 100B have one or more key word tables which define operations of how to display the e-mails in accordance with the detected key words and/or key marks. There is no particular limitation to the key word tables. The key word table may include one or more predetermined key words and/or one or more key marks as well as predetermined display operations correspondent to the predetermined key words or key marks. Namely, the key word table may include at least one key word or one key mark.

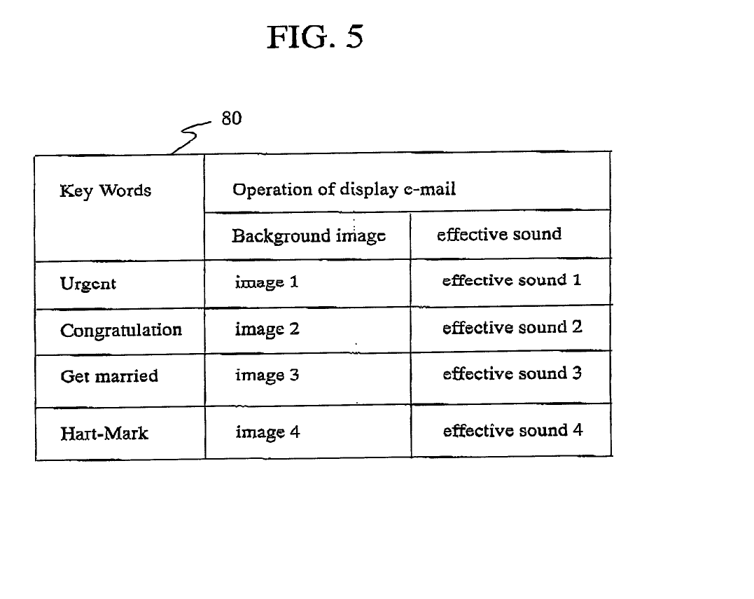

One example of the available key word tables may be as shown in FIG. 5. A key word table 80 includes predetermined three key words and a single key mark and four sets of predetermined background images and predetermined effective sounds in correspondence with the three key words and the single key mark. If the first key word “urgent” is detected by the device, then the device displays the predetermined background image 1 with or without replaying the predetermined effective sound 1. If the second key word “congratulation” is detected by the device, then the device displays the predetermined background image 2 with or without replaying the predetermined effective sound 2. If the third key word “get married” is detected by the device, then the device displays the predetermined background image 3 with or without replaying the predetermined effective sound 3. If the first key mark “ ” is detected by the device, then the device displays the predetermined background image 4 with or without replaying the predetermined effective sound 4.

The first wire-less terminal device 100A may receive e-mails transmitted through the network system of FIG. 3 from the second wire-less terminal device 100B, the wired potable personal computer 110 and the wired installed type personal computer 120 The first wire-less terminal device 100A has the antenna 41 which receives the radio wave transmitted from the base station 210. The radio wave is converted by the antenna 41 to an analog signal. The analog signals are then demodulated by the communication unit 40 into digital data. The digital data are transmitted to the central processing unit 10 The digital data are then stored in the random access memory 50 as e-mail data shown in FIG. 4. The user operates the operation unit 30 to display the e-mail on the display unit 20.

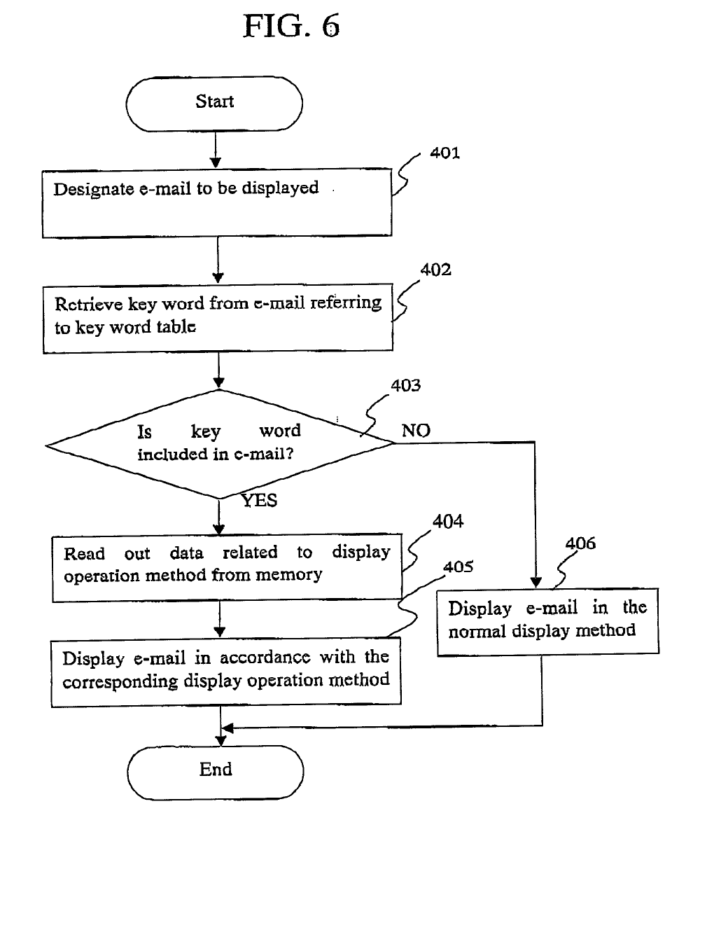

The first wireless terminal device 100A performs the operations of displaying the received e-mail as shown in FIG. 6. In a step 401, the user operates the operation unit 30 to designate one of the e-mails 70 stored in the random access memory 50. In a step 402, in accordance with the computer program having read out from the read only memory 60, the central processing unit 10 retrieves one or more predetermined key words or key mark with reference to the key word table 80 stored in the random access memory 50. The extent of the retrieval is optional. The key words or the key mark may be retrieved from the title 71 alone or in combination with the e-mail content or text data 74.

In a step 403, in accordance with the computer program hating read out from the read only memory 60, the central processing unit 10 verifies whether any one of the key words and/or key mark are included in the e-mail. If any one of the key words and/or key mark are included in the e-mail, then in a step 404, the central processing unit 10 further retrieves with reference to the key word table 80 and read out the corresponding background image data and the effective sound data from the random access memory 50. In a step 405, in accordance with the computer program, the central processing unit 10 controls the display unit 20 to display the e-mail in accordance with the corresponding background image data and the effective sound data. If no key word nor key mark is included in the e-mail, then in a step 406, in accordance with the computer program, the central processing unit 10 controls the display unit 20 to display the e-mail in accordance with the conventional or normal measure.

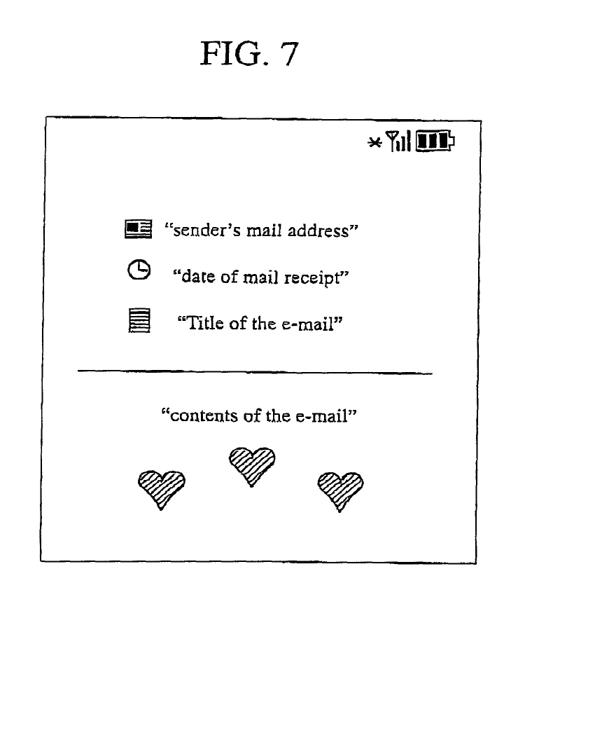

The e-mail as designated by the user is displayed as illustrated in FIG. 7. The title 71 of the e-mail 70 includes the hart-mark which is the key mark listed on the key word table 80. The background image 4 and the effective sound 4 correspond to the hart-mark as key mark. Thus, the e-mail is displayed with the background image 4 and replying the effective sound 4. The background image 4 and the effective sound 4 have been read out of the random access memory 50.

The terminal device 100 displays the e-mail with the background image and the effective sound which are correspondent to the key word or the key mark in accordance with the key word table 80.

As described above, the extent of the retrieval may not be limited to the title of the e-mail. The extent of the retrieval may be not only the title of the e-mail but also the text of the e-mail.

Alternatively, it is also possible that the retrieval may be made based on the sender's address and/or the mail receiving date, so that a background image and an effective sound, which are correspondent to the retrieved address and/or date, are read out of the table stored in the random access memory, whereby the e-mail is displayed with the corresponding background image and the corresponding effective sound.

In place of the background image and the effective sound, other display measures may be previously set on the key table in correspondence to predetermined key object to be retrieved, for example, the key word, the key mark, the sender's address and/or the mail receiving date.

The above image data and the effective sound data corresponding to the respective key word or key mark may optionally be stored in the form of the image file and the effective sound file, wherein the image file and the effective sound file may be read out by designating directly paths thereof. The key word table 80 has no substantive image data and the effective sound data. The key word table 80 has the data defining the image data and the effective sound data stored in the memory, for example, the data may be addresses of the memory, where the image data file and the effective sound data file are stored.

The key word table 80 may be edited, changed or revised or modified in the user's discretion. The key objects such as the key words or the key marks may be rewritten by the user through operating the operation unit. The display operations such as the background image and the effective sound by the user through operating the operation unit. Namely, the user enables to make the key table in his or her discretion. Namely, the key word table may be edited and exchangeable to other device. It is, of course, possible to set the common key word table to plural different users for the plural different terminal devices.

It is also possible that one or more prepared key word tables may be opened on a web-site of the internet established by an administrator, so that the users may have accesses to the web-site for downloading the key word tables.

It is also possible that the user may send the e-mail with an attached file including his or her prepared one or more key word tables to other user. Alternatively, the user may open the key word tables on his or her allocated web-site established by the administrator, so that the other user may have accesses to the web-site for downloading the key word tables.

If the e-mail communications are made between or among the terminal devices having the common key word table, it is unnecessary to attach the key word table to the e-mail for reducing the communication traffic.

If the receiver's terminal device has no key word table or a different key word table from the sender's terminal device, then it may be necessary to attach the key word table to the e-mail.

Namely, the key table defines one or more key objects, to be retrieved from a predetermined extent of the e-mail, and data designating one or more predetermined display operations which correspond to respective one of the key objects. The extent of the e-mail for the retrieval is optional.

The above first embodiment may be modified in the key word table as FIG. 5. In the first embodiment, as described above, the image data and the effective sound data corresponding to the respective key word or key mark are stored in the memory in the form of the image file and the effective sound file, wherein the image file and the effective sound file may be read out by designating directly paths thereof. The above key word table 80 of FIG. 5 has no substantive image data and the effective sound data. The key word table 80 has the data defining the image data and the effective sound data stored in the memory.

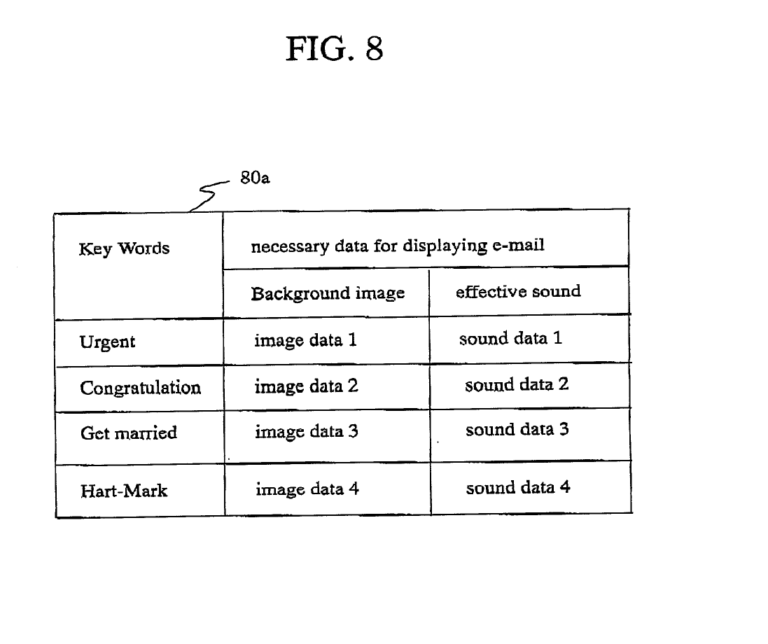

By contrast to the above key word table 80 of FIG. 5, the key word table 80a of FIG. 8 has the substantive image data and the effective sound data. It is unnecessary to have accesses to the memory for reading out the substantive image data and the effective sound data from the memory. The display may be carried out by access to the key word table 80a only. Namely, the key word table 80a includes all of the necessary data for displaying the background image and replaying the effective sounds in displaying the e-mail.

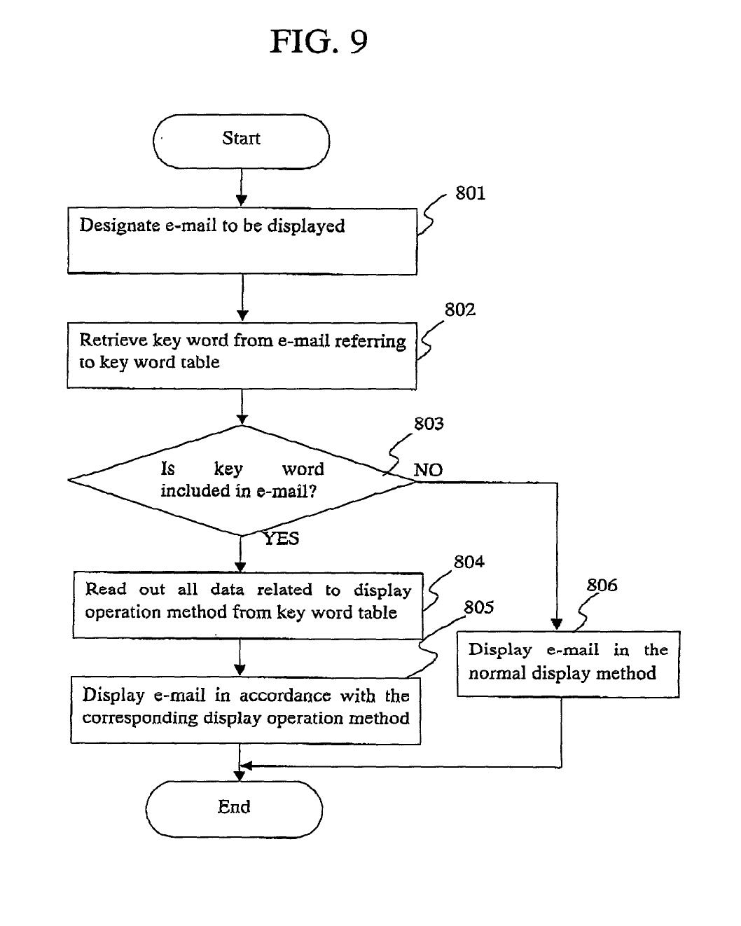

The terminal device performs the operations of displaying the received e-mail as shown in FIG. 9. In a step 801, the user operates the operation unit 30 to designate one of the e-mails 70 stored in the random access memory 50. In a step 802, in accordance with the computer program having read out from the read only memory 60, the central processing unit 10 retrieves one, or more predetermined key words or key mark with reference to the key word table 80 stored in the random access memory 50. The extent of the retrieval is optional. The key words or the key mark may be retrieved from the title 71 alone or in combination with the e-mail content or text data 74.

In a step 803, in accordance with the computer program having read out from the read only memory 60, the central processing unit 10 verifies whether any one of the key words and/or key mark are included in the e-mail. If any one of the key words and/or key mark are included in the e-mail, then in a step 804, the central processing unit 10 further retrieves and read out the corresponding background image data and the effective sound data from the key word table 80a. In a step 805, in accordance with the computer program, the central processing unit 10 controls the display unit 20 to display the e-mail in accordance with the corresponding background image data and the effective sound data. If no key word nor key mark is included in the e-mail, then in a step 806, in accordance with the computer programs the central processing unit 10 controls the display unit 20 to display the e-mail in accordance with the conventional or normal measure.

The terminal device 100 displays the e-mail with the background image and the effective sound which are correspondent to the key word or the key mark in accordance with the key word table 80a.

As described above, the extent of the retrieval may not be limited to the title of the e-mail. Thc extent of the retrieval may be not only the title of the e-mail but also the text of the e-mail.

Alternatively, it is also possible that the retrieval may be made based on the sonder's address and/or the mail receiving date, so that a background image and an effective sound, which are correspondent to the retrieved address and/or date, are read out of the table stored in the random access memory, whereby the e-mail is displayed with the corresponding background image and the corresponding effective sound.

In place of the background image and the effective sound, other display measures may be previously set on the key table in correspondence to predetermined key object to be retrieved, for example, the key word, the key mark, the sender's address and/or the mail receiving date.

The above image data and the effective sound data corresponding to the respective key word or key mark are recorded on the key word table 80a. The key word table 80a has to substantive image data and the effective sound data in the form of data file or different form.

The key word table 80a may also be edited, changed or revised or modified in the user's discretion. The key objects such as the key words or the key marks may be rewritten by the user through operating the operation unit. The display operations such as the background image and the effective sound by the user through operating the operation unit. Namely, the user enables to make the key table in his or her discretion. Namely, the key word table may be edited and exchangeable to other device. It is, of course, possible to set the common key word table to plural different users for the plural different terminal devices.

It is also possible that one or more prepared key word tables may be opened on a web-site of the internet established by an administrator, so that the users may have accesses to the web-site for downloading the key word tables.

It is also possible that the user may send the e-mail with an attached file including his or her prepared one or more key word tables to other user. Alternatively, the user may open the key word tables on his or her allocated web-site established by the administrator, so that the other user may have accesses to the web-site for downloading the key word tables.

If the e-mail communications are made between or among the terminal devices having the common key word table, it is unnecessary to attach the key word table to the e-mail for reducing the communication traffic.

If the receiver's terminal device has no key word table or a different key word table from the sender's terminal device, then it may be necessary to attach the key word table to the e-mail.

Namely, the key table defines one or more key objects, to be retrieved from a predetermined extent of the e-mail, and substantive all data related to one or more predetermined display operations which correspond to respective one of the key objects. The extent of the e-mail for the retrieval is optional.

The above sequential operations of the terminal device shown in FIGS. 6 and 9 may be realized by hardware or software with loading computer programs.

The terminal device 100 has a first function block of managing the one or more key word tables. The terminal device 100 also has a second function block of retrieving one or more key words from the e-mail with reference to the key word table. The terminal device 100 also has a third function block of displaying the e-mail with the background image corresponding to the retrieved key word with or without replaying the effective sound corresponding to the retrieved key word. The terminal device 100 also has a fourth function block of transmitting and receiving the key word table through the existent communication network.

The above first to fourth function blocks may be realized by the hardware or the software. For example, a computer program including the above first to fourth functions may be loaded to the memory of the device. This computer program may be stored in a magnetic disk, a semiconductor memory or any other available storage medium. The computer program is loaded to the memory, to which the processing unit may access directly, so that the processing unit performs the operations under the control of the computer program.

In place of using the storage medium, the computer program may be open on the server established by the administrator, so that the user may have the access to the server through the communication network for downloading the computer program.

The above-described novel communication system free from the problems engaged with the conventional communication system. The above-described novel communication system allows a terminal device of a counter-party to display and/or replay multimedia data including image and/or voice or sound data which have been designated by the user, without any additional operation of downloading the multimedia data, so as to realize desirable high speed communications of the e-mail including the multimedia data such as image data to be displayed and/or voice or sound data to be replayed.

The above-described novel communication system is free of any serious problem with communication-traffic delay.

The above-described novel communication system arranges or adopts received respective informations for realizing the desirable display on a single display screen.

The above-described novel communication system is capable of automatically switching or selecting display operations via automatic detection of one or more designated key words from text or titles of the e-mails.

The above-described novel communication system is capable of automatically controlling the background display or the effective sound or voice ill accordance with character-only-descriptions.

The above-described novel communication system includes a display-operation-defining table which defines the display operation, wherein the display-operation-defining table is programmable by user through any available interface in order to optionally define the display-operations in the user's discretion.

The above-described novel communication system includes a display-operation-defining table which defines the display operation, wherein the display-operation-defining table is inter-exchangeable between communication devices through a communication network such as internet.

The above-described novel communication system utilizes a display-operation-defining table which defines the display operation, wherein the display-operation-defining table common to plural users.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A communication system including:
a communication network; and
a plurality of terminal device connectable to said communication network for transmitting and receiving an information through said communication network;
wherein said communication system includes at least a table which provides at least a retrieval condition and at least a corresponding display method to said at least retrieval condition, so as to enable said terminal device to perform a retrieval to said information under said at least retrieval condition and to display said information in accordance with said at least corresponding display method.

2. The communication system as claimed in claim 1, wherein said table comprises a key table which defines at least a key object and at least a corresponding display method to said key object.

3. The communication system as claimed in claim 2, wherein said at least key object comprise at least one of selected from the group consisting of key words and key marks.

4. The communication system as claimed in claim 1, wherein said table includes designating data which designate necessary data for displaying said information in accordance with said at least corresponding display method.

5. The communication system as claimed in claim 1, wherein said table includes necessary data for displaying said information in accordance with said at least corresponding display method.

6. The communication system as claimed in claim 1, wherein said table is editable.

7. The communication system as claimed in claim 1, wherein said table is transferable through said communication network.

8. The communication system as claimed in claim 1, wherein said information comprises an e-mail.

9. The communication system as claimed in claim 8, wherein said e-mail has at least an attached file.

10. The communication system as claimed in claim 1, wherein said table is stored in a memory of said terminal device.

11. The communication system as claimed in claim 1, wherein said table is open on a server computer on said communication network, so as to enable said terminal device to download said table from said server.

12. The communication system as claimed in claim 1, wherein said terminal device includes:
a first function block for performing said retrieval under said retrieval condition with reference to said table; and
a second function block for displaying said information in accordance with said at least corresponding display method.

13. The communication system as claimed in claim 12, wherein said terminal device further includes:
a third function block for transmitting and receiving said table through said communication network.

14. The communication system as claimed in claim 1, wherein said terminal device includes:
a processing unit; and
a memory accessible by said processing unit, and said memory storing a computer program comprising the steps of:
performing said retrieval under said retrieval condition with reference to said table; and
displaying said information in accordance with said at least corresponding display method.

15. The communication system as claimed in claim 14, wherein said computer program further comprising the step of transmitting and receiving said table through said communication network.

16. A terminal device connectable to a communication network, said terminal device comprising:
a processing unit;
a communication unit electrically coupled to said processing unit for transmitting and receiving an information;
a display unit electrically coupled to said processing unit for displaying said information;
an operation unit electrically coupled to said processing unit for operating said terminal device; and
a memory unit electrically coupled to said processing unit for storing at least a table which provides at least a retrieval condition and at least a corresponding display method to said at least retrieval condition, so as to enable said terminal device to perform a retrieval to said information under said at least retrieval condition and to display said information in accordance with said at least corresponding display method.

17. The terminal device as claimed in claim 16, wherein said table comprises a key table which defines at least a key object and at least a corresponding display method to said key object.

18. The terminal device as claimed in claim 17, wherein said at least key object comprise at least one of selected from the group consisting of key words and key marks.

19. The terminal device as claimed in claim 16, wherein said table includes designating data which designate necessary data for displaying said information in accordance with said at least corresponding display method.

20. The terminal device as claimed in claim 16, wherein said table includes necessary data for displaying said information in accordance with said at least corresponding display method.

21. The terminal device as claimed in claim 16, wherein said table is editable.

22. The terminal device as claimed in claim 16, wherein said table is transferable from said communication unit through said communication network.

23. The terminal device as claimed in claim 16, wherein said information comprises an e-mail.

24. The terminal device as claimed in claim 23, wherein said e-mail has at least an attached file.

25. The terminal device as claimed in claim 16, wherein said terminal device includes:
a first function block for performing said retrieval under said retrieval condition with reference to said table; and
a second function block for displaying said information in accordance with said at least corresponding display method.

26. The terminal device as claimed in claim 25, wherein said tensional device further includes:
a third function block for transmitting and receiving said table through said communication network.

27. The terminal device as claimed in claim 16, wherein said memory stores a computer program comprising the stops of:
performing said retrieval under said retrieval condition with reference to said table; and
displaying said information in accordance with said at least corresponding display method.

28. The terminal device as claimed in claim 27, wherein said computer program further comprising the step of transmitting and receiving said table through said communication network.

29. A terminal device connectable to a communication network, said terminal device includes:
a first function block for performing a retrieval to an information under at least a retrieval condition; and
a second function block for displaying said information in accordance with at least a corresponding display method to said at least a retrieval condition.

30. The terminal device as claimed in claim 29, wherein said at least retrieval condition and said at least corresponding display method are recorded on a table.

31. The terminal device as claimed in claim 30, wherein said table comprises a key table which defines at least a key object and at least a corresponding display method to said key object.

32. The terminal device as claimed in claim 30, wherein said table includes designating data which designate necessary data for displaying said information in accordance with said at least corresponding display method.

33. The terminal device as claimed in claim 30, wherein said table includes necessary data for displaying said information in accordance with said at least corresponding display method.

34. The terminal device as claimed in claim 30, wherein said table is editable.

35. The terminal device as claimed in claim 30, wherein said table is transferable from said communication unit through said communication network.

36. The terminal device as claimed in claim 30, wherein said information comprises an e-mail.

37. The terminal device as claimed in claim 36, wherein said e-mail has at least an attached file.

38. A method of displaying an information, comprising the steps of:
performing a retrieval to an information under at least a retrieval condition; and
displaying said information in accordance with at least a corresponding display method to said at least a retrieval condition.

39. The method as claimed in claim 38, wherein said retrieval is performed with reference to at least a table which provides at least a retrieval condition and at least a corresponding display method to said at least retrieval condition, and said information is displayed in accordance with said at least corresponding display method.

40. The method as claimed in claim 39, wherein said table comprises a key table which defines at least a key object and at least a corresponding display method to said key object.

41. The method as claimed in claim 40, wherein said at least key object comprise at least one of selected from the group consisting of key words and key marks.

42. The method as claimed in claim 39, wherein said table includes designating data which designate necessary data for displaying said information in accordance with said at least corresponding display method.

44. The method as claimed in claim 43, further comprising the step of reading out said necessary data in accordance with said designating data before displaying said information.

45. The method as claimed in claim 39, wherein said table includes necessary data for displaying said information in accordance with said at least corresponding display method.

46. The method as claimed in claim 39, wherein said information comprises an e-mail.

47. The method as claimed in claim 46, wherein said e-mail has at least an attached file.

48. A computer program of displaying an information, said computer program comprising:
performing a retrieval to an information under at least a retrieval condition; and
displaying said information in accordance with at least a corresponding display method to said at least a retrieval condition.

49. The computer program as claimed in claim 48, wherein said retrieval is performed with reference to at least a table which provides at least a retrieval condition and at least a corresponding display method to said at least retrieval condition, and said information is displayed in accordance with said at least corresponding display method.

50. The computer program as claimed in claim 49, wherein said table comprises a key table which defines at least a key object and at least a corresponding display method to said key object.

51. The computer program as claimed in claim 50, wherein said at least key object comprise at least one of selected from the group consisting of key words and key marks.

52. The computer program as claimed in claim 49, wherein said table includes designating data which designate necessary data for displaying said information in accordance with said at least corresponding display method.

54. The computer program as claimed in claim 53, further comprising the step of: reading out said necessary data in accordance with said designating data before displaying said information.

55. The computer program as claimed in claim 49, wherein said table includes necessary data for displaying said information in accordance with said at least corresponding display method.

56. The computer program as claimed in claim 49, wherein said information comprises an e-mail.

57. The computer program as claimed in claim 56, wherein said e-mail has at least an attached file.
